(19) United States
(12) Patent Application Publication
(10) Pub. No.: US 2025/0383553 A1
(43) Pub. Date: Dec. 18, 2025

(54) DIFFRACTIVE OPTICAL ELEMENT

(71) Applicant: GUANGZHOU LUXVISIONS INNOVATION TECHNOLOGY LIMITED, Guangzhou City (CN)

(72) Inventor: Hsiu-Chih Lin, Guangzhou City (CN)

(73) Assignee: GUANGZHOU LUXVISIONS INNOVATION TECHNOLOGY LIMITED, Guangzhou City (CN)

(21) Appl. No.: 18/982,520

(22) Filed: Dec. 16, 2024

(30) Foreign Application Priority Data
Jun. 17, 2024 (CN) 202410784722.4

(51) Int. Cl. G02B 27/42

(52) U.S. Cl. CPC G02B 27/4205

(57) ABSTRACT

A diffractive optical element (DOE) includes a substrate and a surface layer. The substrate has a pattern region. The surface layer has a plurality of sub-patterns. The sub-patterns include a first sub-pattern and a second sub-pattern. The first sub-pattern and the second sub-pattern are spliced and cover the pattern region. The first sub-pattern includes a plurality of first pixels. Each of the first pixels has a first thickness. The first thicknesses are a plurality of first predetermined values. The second sub-pattern includes a plurality of second pixels. Each of the second pixels has a second thickness. The second thicknesses are a plurality of second predetermined values.

### CROSS-REFERENCE TO RELATED APPLICATION

This non-provisional application claims priority under 35 U.S.C. § 119(a) to Patent Application No. 202410784722.4 filed in China on Jun. 17, 2024, the entire contents of which are hereby incorporated by reference.

### BACKGROUND

### Technical Field

The present invention relates to an optical element, and in particular, to a diffractive optical element (DOE).

### Related Art

With the popularization of diffractive optical elements (DOEs), application of DOEs in modern optical systems becomes increasingly extensive. The DOEs are popular for characteristics such as light weight, miniaturization, and multifunction thereof. These elements can realize precise beam control by using the principle of diffraction of light and therefore play an important role in the fields of optical sensing, optical communication, imaging computation, and beam shaping.

### SUMMARY

In view of this, some embodiments of the present invention provide a diffractive optical element (DOE), which includes a substrate and a surface layer. The substrate has a pattern region. The surface layer has a plurality of sub-patterns. The sub-patterns include a first sub-pattern and a second sub-pattern. The first sub-pattern and the second sub-pattern are spliced and cover the pattern region. The first sub-pattern includes a plurality of first pixels. Each of the first pixels has a first thickness. The first thicknesses are a plurality of first predetermined values. The second sub-pattern includes a plurality of second pixels. Each of the second pixel has a second thickness. The second thicknesses are a plurality of second predetermined values.

In some embodiments, the first sub-pattern and the second sub-pattern are spliced at a preset ratio. In some embodiments, an assembled pattern formed by splicing the first sub-pattern and the second sub-pattern completely covers the entire pattern region. In some embodiments, an assembled pattern formed by splicing the first sub-pattern and the second sub-pattern does not completely cover the entire pattern region.

In some embodiments, the first sub-pattern has a first distance, and the second sub-pattern has a second distance. When a light ray passes through the first sub-pattern, the light ray is imaged at the first distance. When the light ray passes through the second sub-pattern, the light ray is imaged at the second distance.

In summary, according to a DOE provided in some embodiments, when the light ray passes through the first pixel and the second pixel with different predetermined thicknesses, a phase of the light ray is changed, so that the light ray is imaged as a first diffraction pattern at the first distance and imaged as a second diffraction pattern at the second distance.

### BRIEF DESCRIPTION OF THE DRAWINGS

FIG. 1 is a three-dimensional schematic diagram of a diffractive optical element (DOE) according to some embodiments;

FIG. 2 is a three-dimensional exploded view of FIG. 1;

FIG. 3 is a partial schematic enlarged view of an assembled pattern according to some embodiments, where the assembled pattern is formed by splicing a first sub-pattern and a second sub-pattern;

FIG. 4 is a schematic cross-sectional view of FIG. 3 at a position 4-4′, which shows first thicknesses of first pixels and second thicknesses of second pixels;

FIG. 5-1, FIG. 5-2, and FIG. 5-3 are schematic diagrams of a first microstructure pattern, a second microstructure pattern, a first sub-pattern, a second sub-pattern, and an assembled pattern according to some embodiments;

FIG. 6 is a schematic diagram of an assembled pattern according to some embodiments;

FIG. 7 is a schematic diagram of application of a DOE according to some embodiments, which shows a schematic diagram showing imaging of a light ray passing through the DOE at different distances; and

FIG. 8 is a partial schematic enlarged view of an assembled pattern according to some embodiments, where the assembled pattern is formed by splicing a first sub-pattern, a second sub-pattern, and a third sub-pattern.

### DETAILED DESCRIPTION

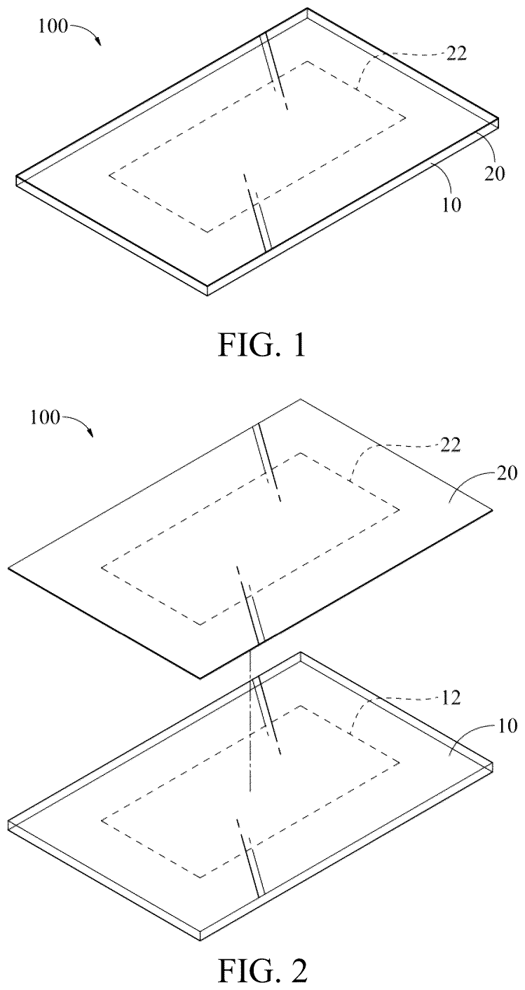

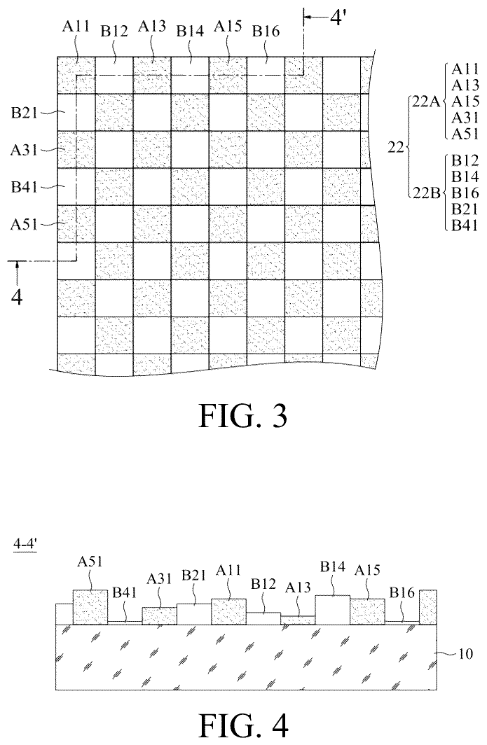

Referring to FIG. 1 and FIG. 2, FIG. 1 is a three-dimensional schematic diagram of a diffractive optical element (DOE) according to some embodiments. FIG. 2 is a three-dimensional exploded view of FIG. 1. FIG. 3 is a partial schematic enlarged view of an assembled pattern according to some embodiments, where the assembled pattern is formed by splicing a first sub-pattern and a second sub-pattern. A DOE 100 includes a substrate 10 and a surface layer 20. The substrate 10 has a pattern region 12. The surface layer 20 has a plurality of sub-patterns 22A and 22B. The sub-patterns 22A and 22B include a first sub-pattern 22A and a second sub-pattern 22B. The first sub-pattern 22A and the second sub-pattern 22B are spliced and cover the pattern region 12. The first sub-pattern 22A includes a plurality of first pixels A11, A13, A15, A31, and A51. Each of the first pixels A11, A13, A15, A31, and A51 has a first thickness. The first thicknesses are a plurality of first predetermined values. The second sub-pattern 22B includes a plurality of second pixels B12, B14, B16, B21, and B41. Each of the second pixels B12, B14, B16, B21, and B41 has a second thickness. The second thicknesses are a plurality of second predetermined values. A pattern formed by splicing the first sub-pattern 22A and the second sub-pattern 22B is referred to as an assembled pattern 22. In some embodiments, the assembled pattern 22 formed by splicing the first sub-pattern 22A and the second sub-pattern 22B completely covers the pattern region 12. In some embodiments, the assembled pattern 22 formed by splicing the first sub-pattern 22A and the second sub-pattern 22B does not completely cover the pattern region 12.

Referring to FIG. 4 together, FIG. 4 is a schematic sectional view of FIG. 3 at a position 4-4′, which shows first thicknesses of the first pixels A11, A13, A15, A31, and A51 and second thicknesses of the second pixels B12, B14, B16, B21, and B41. It may be learned from the figure that each of the first pixels A11, A13, A15, A31, and A51 has a corresponding first thickness, and each of the first thicknesses is one of the first predetermined values. Each of the second pixels B12, B14, B16, B21, and B41 has a corresponding second thickness, and each of the second thicknesses is one of the second predetermined values.

Still referring to FIG. 4, in some embodiments, 4 first predetermined values are provided. The four first predetermined values are respectively 470 nm (nanometer), 940 nm, 1410 nm, and 1880 nm. In other words, the first thickness of each first pixel is one of 470 nm, 940 nm, 1410 nm, and 1880 nm. 4 second predetermined values are also provided. The four second predetermined values are respectively 188 nm, 658 nm, 1128 nm, and 1598 nm. In other words, the second thickness of each second pixel is one of 188 nm, 658 nm, 1128 nm, and 1598 nm. In some embodiments, a quantity of the first predetermined values is different from a quantity of the second predetermined values. In some embodiments, the quantity of the first predetermined values and the quantity of the second predetermined values are multiples of two or not multiples of two. In some embodiments, one of the first predetermined values is the same as one of the second predetermined values (that is, one of the first thicknesses is the same as one of the second thicknesses).

In some embodiments, as shown in FIG. 2, a surface area of the surface layer 20 (an area of a top view of FIG. 2) is substantially the same as a surface area of the substrate 10 (an area of the top view of FIG. 2), and the substrate 10 and the surface layer 20 each are made of a light-transmissive material. The light-transmissive material is, for example, but is not limited to, glass, acrylic, or resin. In some embodiments, the surface area of the surface layer 20 is substantially the same the pattern region 12 of the substrate 10. In other words, the surface layer 20 covers the pattern region 12.

In some embodiments, the substrate 10 is optical glass, and the surface layer 20 is a resin layer. The resin layer is attached to the optical glass to form the DOE 100. In some embodiments, the first pixels A11, A13, A15, A31, and A51 of the first sub-pattern 22A of the surface layer 20 and the second pixels B12, B14, B16, B21, and B41 of the second sub-pattern 22B are microstructures with different thicknesses (the first thicknesses and the second thicknesses) on the resin layer.

In some embodiments, the first sub-pattern 22A has a first distance, and the second sub-pattern 22B has a second distance. When a light ray passes through the first sub-pattern 22A, the light ray is imaged at the first distance. When the light ray passes through the second sub-pattern 22B, the light ray is imaged at the second distance. The first distance is less than the second distance. Therefore, the first sub-pattern 22A may be referred to as a near-field microstructure sub-pattern, and the second sub-pattern 22B may be referred to as a far-field microstructure sub-pattern. During the design of each of the sub-patterns, an imaging distance is one of the design parameters. Therefore, each of the sub-patterns 22A, 22B, 22C (22C will be explained later) has an imaging distance which may be named as a first distance, a second distance, or a third distance (third distance will be explained later). The same can be applied to the first distance and a first microstructure pattern mentioned later, the second distance and a second microstructure pattern mentioned later, and a third distance, a third sub-pattern 22C, and a third microstructure pattern mentioned later.

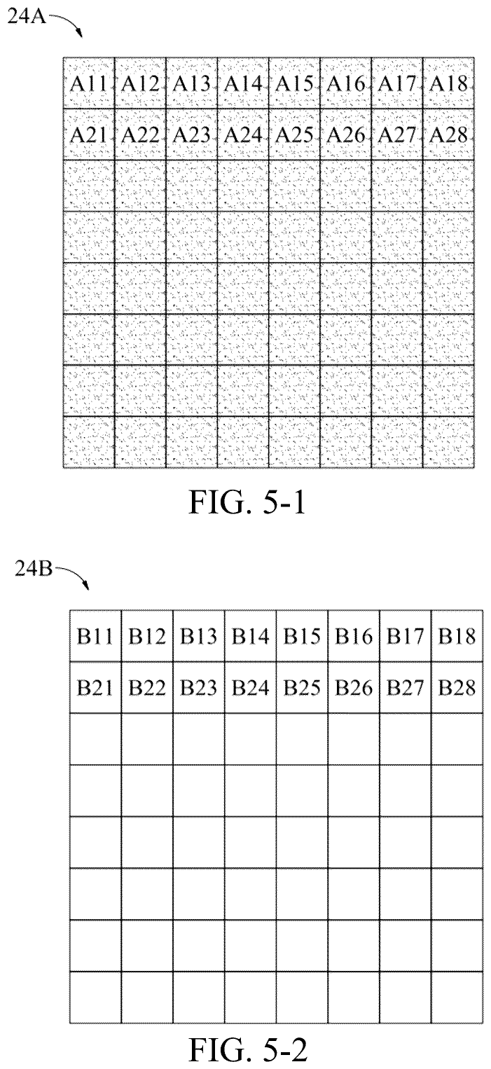

FIG. 5-1, FIG. 5-2, and FIG. 5-3 are schematic diagrams of a first microstructure pattern, a second microstructure pattern, a first sub-pattern, a second sub-pattern, and an assembled pattern according to some embodiments. FIG. 5-1, FIG. 5-2, and FIG. 5-3 respectively each show a pattern with only 64 pixels as an example. FIG. 5-1 shows that a first microstructure pattern 24A includes 64 first pixels (only first pixels A11 to A18 in a first row and first pixels A21 to A28 in a second row are indicated in the figure). FIG. 5-2 shows that a second microstructure pattern 24B includes 64 second pixels (only second pixels B11 to B18 in a first row and second pixels B21 to B28 in a second row are indicated in the figure). A first sub-pattern 22A is part of the first microstructure pattern 24A. A second sub-pattern 22B is part of the second microstructure pattern 24B. The “part” herein means that the first sub-pattern 22A has some of the first pixels of the first microstructure pattern 24A from a viewpoint of pixel, which means that features of the first pixels of the first sub-pattern 22A are the same as features of the first pixels of the corresponding first microstructure pattern 24A. The features are, for example, a position (a coordinate) and a thickness. The second sub-pattern 22B has some of the second pixels of the second microstructure pattern 24B, which means that features of the second pixels of the second sub-pattern 22B are the same as features of the second pixels of the corresponding second microstructure pattern 24B. In the embodiment of FIG. 5-3, a quantity of the first pixels of the first sub-pattern 22A is half of a quantity of the first pixels of the first microstructure pattern 24A, and the positions (the coordinates) and the thicknesses of the first pixels of the first sub-pattern 22A are the same as the positions (the coordinates) and the thicknesses of the first pixels of the corresponding first microstructure pattern 24A. A quantity of the second pixels of the second sub-pattern 22B is half of a quantity of the second pixels of the second microstructure pattern 24B, and the positions (the coordinates) and the thicknesses of the second pixels of the second sub-pattern 22B are the same as the positions (the coordinates) and the thicknesses of the second pixels of the corresponding second microstructure pattern 24B. The coordinates (the positions) of the first pixels of the first sub-pattern 22A and the coordinates (the positions) of the second pixels of the second sub-pattern 22B do not overlap (they are staggered in a checkerboard-like manner). Therefore, an assembled pattern 22 includes 32 first pixels and 32 second pixels.

The first microstructure pattern 24A has a first distance, and the second microstructure pattern 24B has a second distance. When a light ray passes through the first microstructure pattern 24A, the light ray is imaged at the first distance. When the light ray passes through the second microstructure pattern 24B, the light ray is imaged at the second distance. As described above, the first distance is less than the second distance, the first microstructure pattern 24A is referred to as a near-field microstructure pattern, and the second microstructure pattern 24B is referred to as a far-field microstructure pattern. In some embodiments, the quantity of the first pixels of the first microstructure pattern 24A is the same as the quantity of the second pixels of the second microstructure pattern 24B, and is also the same as a quantity of pixels of the assembled pattern. However, the two may also be different. In the assembled pattern 22 in this embodiment, a splicing ratio (a quantity ratio of pixels) of the first sub-pattern 22A and the second sub-pattern 22B is 1:1.

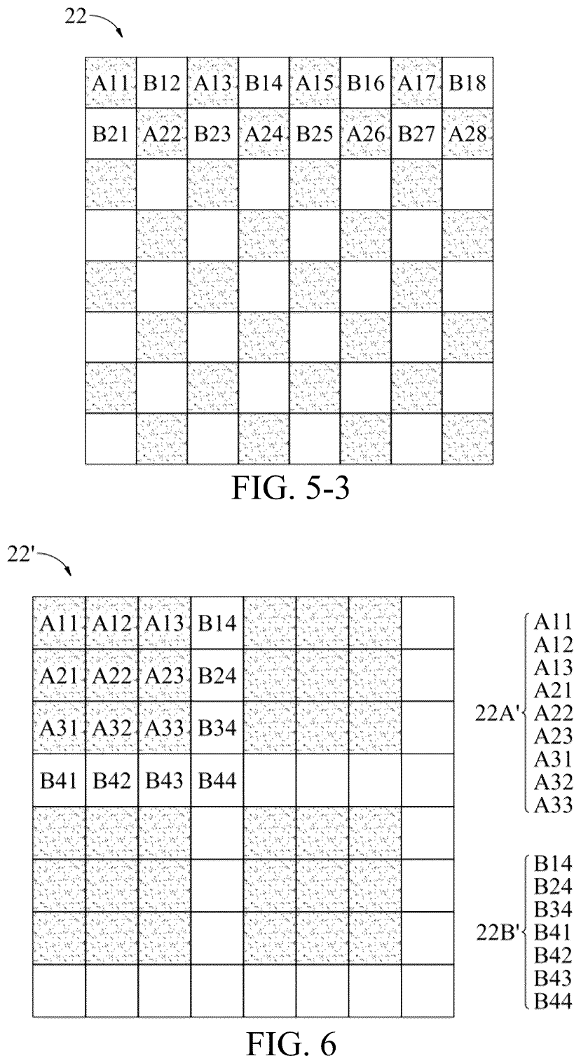

FIG. 6 is a schematic diagram of an assembled pattern according to some embodiments. FIG. 6 shows a pattern with only 64 pixels as an example. In this embodiment, a first sub-pattern 22A′ of an assembled pattern 22′ includes 36 first pixels (for example, pixels each with a first code A in the figure), and a second sub-pattern 22B′ of the assembled pattern 22′ includes 28 second pixels (for example, pixels each with a first code B in the figure). In the assembled pattern 22′ in this embodiment, a splicing ratio (a quantity ratio of pixels) of the first sub-pattern 22A′ and the second sub-pattern 22B′ is 9:7.

It may be learned from FIG. 5-3 and FIG. 6 that the splicing manner in which a plurality of sub-patterns are spliced into an assembled pattern may be adjusted according to a requirement or an imaging result, and is not limited to the splicing manners shown in FIG. 5-3 and FIG. 6.

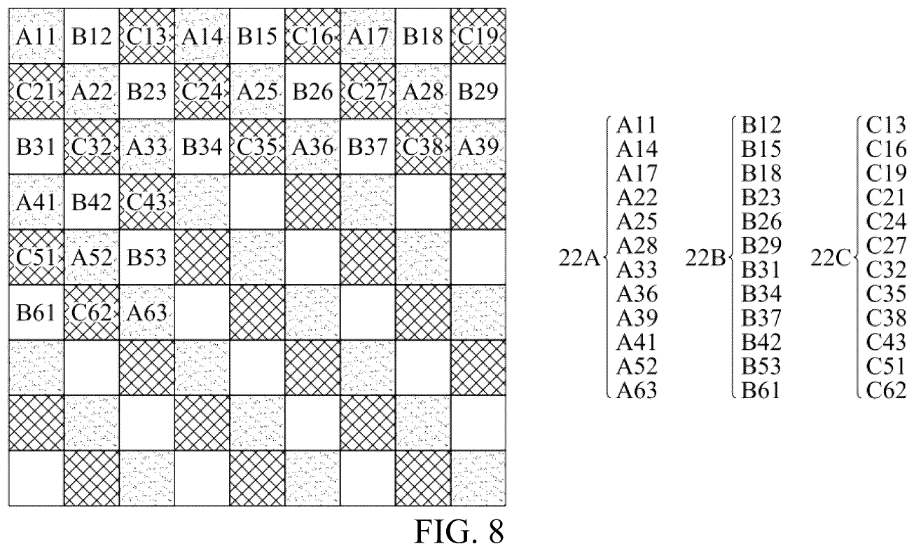

A total quantity of pixels of the assembled patterns 22 and 22′ in the embodiments of FIG. 5-3 and FIG. 6 is the same as a total quantity of pixels of the first microstructure pattern 24A and a total quantity of pixels of the second microstructure pattern 24B. In some embodiments, the quantity of the first pixels of the first sub-patterns 22A and 22A′ plus the quantity of the second pixels of the second sub-patterns 22B and 22B′ of the assembled patterns 22 and 22′ is less than the total quantity of pixels of the first microstructure pattern 24A or the total quantity of pixels of the second microstructure pattern 24B. For example, the quantity of the first pixels of the first sub-patterns 22A and 22A′ is one third of the total quantity of pixels of the first microstructure pattern 24A, and the quantity of second pixels of the second sub-patterns 22B and 22B′ is one third of the total quantity of pixels of the second microstructure pattern 24B. Therefore, although the total quantity of pixels of the assembled patterns 22 and 22′ is the same as a sum of the total quantity of pixels of the first microstructure pattern and the total quantity of pixels of the second microstructure pattern, only two thirds of pixels of the assembled patterns 22 and 22′ have microstructures (which respectively correspond to the first microstructure pattern 24A and the second microstructure pattern 24B), and the splicing manner thereof may be similar to, but is not limited to, a splicing manner shown in FIG. 8 (in this embodiment, thicknesses of pixels numbered C13, C16, C19, C21, C24, C27, C32, C35, C38, C43, C51, and C62 in FIG. 8 do not correspond to a microstructure pattern, or when a light ray passes through the pixels, the light ray is not imaged as a predetermined pattern at a predetermined distance).

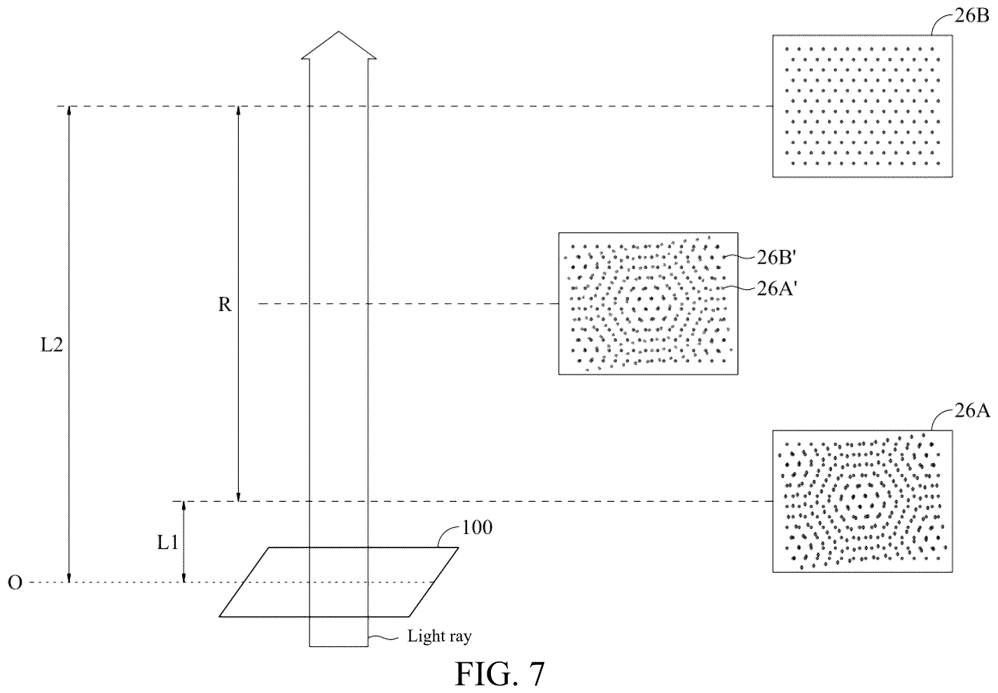

FIG. 7 is a schematic diagram of application of a DOE according to some embodiments, which shows a schematic diagram showing imaging of a light ray passing through the DOE at different distances. As described above, a first sub-pattern 22A of a DOE 100 has a first distance L1, and a second sub-pattern 22B of the DOE 100 has a second distance L2. When a light ray passes through the first sub-pattern 22A, the light ray is imaged as a first diffraction pattern 26A (which is also referred to as a first light spot pattern) at the first distance L1. When the light ray passes through the second sub-pattern 22B, the light ray is imaged as a second diffraction pattern 26B (which is also referred to as a second light spot pattern) at the second distance L2.

Specifically, the DOE 100 is located at a position of an origin point O, and a position of the first distance L1 and a position of the second distance L2 are known. When the light ray passes through the DOE 100, a phase of the light ray is changed as a result of distribution and thicknesses of first pixels, so that the first diffraction pattern 26A is imaged at the first distance L1, and the phase of the light ray is changed as a result of distribution and thicknesses of second pixels, so that the second diffraction pattern 26B is imaged at the second distance L2.

In some embodiments, a transfer interval R is defined between the first distance L1 and the second distance L2. A light spot pattern (which is also referred to as an overlapping pattern) formed in the transfer interval R when the light ray passes through the first sub-pattern 22A is not the complete first diffraction pattern 26A or the complete second diffraction pattern 26B. When the light ray passes through the first sub-pattern 22A and arrives at a position in the transfer interval R, a “varying first diffraction pattern” 26A′ (which is also referred to as a first transfer pattern) is formed. When the light ray passes through the second sub-pattern 22B and arrives at the position in the transfer interval R, a “varying second diffraction pattern” 26B′ (which is also referred to as a second transfer pattern) is formed. The overlapping pattern is formed by overlapping the first transfer pattern 26A′ and the second transfer pattern 26B′. The overlapping pattern varies with a position thereof in the transfer interval R. When the position of the overlapping pattern is relatively close to the first distance L1, the overlapping pattern is relatively close to the first diffraction pattern 26A. When the position of the overlapping pattern is relatively close to the second distance L2, the overlapping pattern is relatively close to the second diffraction pattern 26B.

Still referring to FIG. 7, in some embodiments, the first microstructure pattern 24A and the second microstructure pattern 24B are manufactured in the following manner. First, a far-field target pattern (that is, the second diffraction pattern 26B) is designed as a regular matrix of spots (as shown in FIG. 7) based on a known light source condition. Next, a near-field target pattern (that is, the first diffraction pattern 26A) is designed as a random point target pattern. The far-field target pattern 26B is copied first and is rotated by a predetermined angle, for example, but not limited to, 8 degrees. Then the rotated far-field target pattern 26B overlaps with an original far-field target pattern to obtain the near-field target pattern of the random point. Then the near-field target pattern 26A, the first distance L1 (for example, 60 cm), and another known condition are substituted into an Iterative Fourier Transform Algorithm to generate a near-field phase distribution pattern. In addition, the far-field target pattern 26B, the second distance L2 (for example, 100 cm), and another known condition are substituted into the Iterative Fourier Transform Algorithm, to generate a far-field phase distribution pattern. Next, the near-field phase distribution pattern and the far-field phase distribution pattern are substituted into an optimization algorithm, so that a near-field microstructure pattern (that is, the first microstructure pattern 24A) and a far-field microstructure pattern (that is, the second microstructure pattern 24B) can be obtained. The above another known conditions may be, but not limited to, optical parameters such as a light source wavelength, a light source position, and a microstructure pixel size of a light source and a diffractive element. The above manufacturing manner is merely an example, and the present invention is not limited thereto.

Referring to FIG. 8, FIG. 8 is a partial schematic enlarged view of an assembled pattern according to some embodiments, where the assembled pattern is formed by splicing a first sub-pattern, a second sub-pattern, and a third sub-pattern. FIG. 8 shows a pattern with only 81 pixels as an example, and the figure only indicates numbers of some pixels based on positions (coordinates) thereof. It may be learned from the figure that, in this embodiment, a surface layer of a DOE includes a first sub-pattern 22A, a second sub-pattern 22B, and a third sub-pattern 22C. The first sub-pattern 22A, the second sub-pattern 22B, and the third sub-pattern 22C are spliced and cover a pattern region (not shown in the figure, refer to FIG. 2) of a substrate of the DOE. The first sub-pattern 22A includes a plurality of first pixels A11, A14, A17, A22, A25, A28, A33, A36, A39, A41, A52, and A63, the second sub-pattern 22B includes a plurality of second pixels B12, B15, B18, B23, B26, B29, B31, B34, B37, B42, B53, and B61, and the third sub-pattern 22C includes a plurality of third pixels C13, C16, C19, C21, C24, C27, C32, C35, C38, C43, C51, and C62. Each of the first pixels A11, A14, A17, A22, A25, A28, A33, A36, A39, A41, A52, and A63 has a first thickness, and the first thicknesses are a plurality of first predetermined values. Each of the second pixels B12, B15, B18, B23, B26, B29, B31, B34, B37, B42, B53, and B61 has a second thickness, and the second thicknesses are a plurality of second predetermined values. Each of the third pixels C13, C16, C19, C21, C24, C27, C32, C35, C38, C43, C51, and C62 has a third thickness, and the third thicknesses are a plurality of third predetermined values. The first thickness, the second thickness, the third thickness, each of the first predetermined values, each of the second predetermined values, and each of the third predetermined values are similar to those in the above embodiments, and therefore details are not described herein again.

In this embodiment, the first sub-pattern 22A is part of a first microstructure pattern (not shown, similar to that in FIG. 5-1), the second sub-pattern 22B is part of a second microstructure pattern (not shown, similar to that in FIG. 5-2), and the third sub-pattern is part of a third microstructure pattern (not shown, similar to that in FIG. 5-1, but A is replaced with C; or similar to that in FIG. 5-2, but B is replaced with C). The first sub-pattern 22A and the first microstructure pattern have a first distance, the second sub-pattern 22B and the second microstructure pattern have a second distance, and the third sub-pattern 22C and the third microstructure pattern have a third distance. When a light ray passes through the first sub-pattern 22A, the light ray is imaged as a first diffraction pattern (not shown) at the first distance. When the light ray passes through the second sub-pattern 22B, the light ray is imaged as a second diffraction pattern (not shown) at the second distance. When the light ray passes through the third sub-pattern 22C, the light ray is imaged as a third diffraction pattern (not shown) at the third distance. The drawings do not show the first diffraction pattern, the second diffraction pattern, and the third diffraction pattern in this embodiment, and the reason is that, as described above, the first diffraction pattern, the second diffraction pattern, and the third diffraction pattern are light spots corresponding to target patterns designed in advance based on the light source condition, and are similar to 26A or 26B in FIG. 7. Therefore, the light spots of the diffraction patterns correspond to the target patterns thereof.

Furthermore, a splicing manner of the first sub-pattern 22A, the second sub-pattern 22B, and the third sub-pattern 22C is not limited to the splicing manner in the embodiment of FIG. 8, and another splicing manner may be adopted during implementation, which uses a principle in which the first diffraction pattern, the second diffraction pattern, and the third diffraction pattern are respectively imaged at the first distance, the second distance, and the third distance after the light ray passes.

In some embodiments, a plurality of sub-patterns of the surface layer of the DOE include a first sub-pattern, a second sub-pattern, a third sub-pattern, and a fourth sub-pattern (not shown in the figures), and an assembled pattern is formed by splicing the first sub-pattern, the second sub-pattern, the third sub-pattern, and the fourth sub-pattern. Detailed features are similar to those described above and therefore are not described herein again. Therefore, when a light ray passes through the DOE with four sub-patterns, the light ray is imaged as a first diffraction pattern, a second diffraction pattern, a third diffraction pattern, and a fourth diffraction pattern at a first distance, a second distance, a third distance, and a fourth distance.

In summary, according to some embodiments, the DOE includes the substrate and the surface layer. The substrate has the pattern region, and the surface layer includes a plurality of sub-patterns. The sub-patterns are spliced into the assembled pattern and cover the pattern region. Each of the sub-patterns corresponds to an imaging distance. When the light ray passes through the pattern region, the phase of the light ray is affected by the pixels of each sub-pattern, and therefore is imaged as the predetermined diffraction patterns at the distances.

What is claimed is:

1. A diffractive optical element (DOE), comprising:
a substrate, having a pattern region; and
a surface layer, having a plurality of sub-patterns, wherein the sub-patterns comprise a first sub-pattern and a second sub-pattern, the first sub-pattern and the second sub-pattern are spliced and cover the pattern region, the first sub-pattern comprises a plurality of first pixels, each of the first pixels has a first thickness, the first thicknesses are a plurality of first predetermined values, the second sub-pattern comprises a plurality of second pixels, each of the second pixels has a second thickness, and the second thicknesses are a plurality of second predetermined values.

2. The DOE according to claim 1, wherein the pattern region is located on a surface of the substrate.

3. The DOE according to claim 1, wherein the substrate and the surface layer each are made of a light-transmissive material.

4. The DOE according to claim 1, wherein the first sub-pattern and the second sub-pattern are spliced at a preset ratio.

5. The DOE according to claim 1, wherein the first sub-pattern is part of a first microstructure pattern, the second sub-pattern is part of a second microstructure pattern, the first sub-pattern and the first microstructure pattern have a first distance, the second sub-pattern and the second microstructure pattern have a second distance, when a light ray passes through the first sub-pattern, the light ray is imaged as a first diffraction pattern at the first distance, and when the light ray passes through the second sub-pattern, the light ray is imaged as a second diffraction pattern at the second distance.

6. The DOE according to claim 5, wherein a transfer interval is defined between the first distance and the second distance, when the light ray passes through the first sub-pattern, a first transfer pattern is formed at a position in the transfer interval, when the light ray passes through the second sub-pattern, a second transfer pattern is formed at the position in the transfer interval, and the first transfer pattern and the second transfer pattern overlap to form an overlapping pattern.

7. The DOE according to claim 6, wherein a light intensity of the first transfer pattern and a light intensity of the second transfer pattern vary with the position of the transfer interval.

8. The DOE according to claim 5, wherein the first distance is different from the second distance.

9. The DOE according to claim 8, wherein a transfer interval is defined between the first distance and the second distance, when the light ray passes through the first sub-pattern, a first transfer pattern is formed at a position in the transfer interval, when the light ray passes through the second sub-pattern, a second transfer pattern is formed at the position in the transfer interval, and the first transfer pattern and the second transfer pattern overlap to form an overlapping pattern.

10. The DOE according to claim 9, wherein a light intensity of the first transfer pattern and a light intensity of the second transfer pattern vary with the position of the transfer interval.

11. The DOE according to claim 1, wherein the sub-patterns further comprise a third sub-pattern, the first sub-pattern, the second sub-pattern, and the third sub-pattern are spliced and cover the pattern region, the third sub-pattern comprises a plurality of third pixels, each of the third pixels has a third thickness, and the third thicknesses are a plurality of third predetermined values.

12. The DOE according to claim 11, wherein the first sub-pattern is part of a first microstructure pattern, the second sub-pattern is part of a second microstructure pattern, the third sub-pattern is part of a third microstructure pattern, the first sub-pattern and the first microstructure pattern have a first distance, the second sub-pattern and the second microstructure pattern have a second distance, the third sub-pattern and the third microstructure pattern have a third distance, when a light ray passes through the first sub-pattern, the light ray is imaged as a first diffraction pattern at the first distance, when the light ray passes through the second sub-pattern, the light ray is imaged as a second diffraction pattern at the second distance, and when the light ray passes through the third sub-pattern, the light ray is imaged as a third diffraction pattern at the third distance.
